(19) United States
(12) Patent Application Publication
(10) Pub. No.: US 2002/0119025 A1
(43) Pub. Date: Aug. 29, 2002

(54) Blind Rivet

(76) Inventors: Klaus Wirth, Tettnang (DE); Martin Wirth, Landsberg (DE)

Correspondence Address: Schuster & Partner, Patentanwalte, Wiederholdstrasse 10, Stuttgart, D-70174, DE

(21) Appl. No.: 10/053,711

(22) Filed: Jan. 24, 2002

(30) Foreign Application Priority Data
Jan. 30, 2001 (DE) 101 04 282.5
May 18, 2001 (DE) 101 25 209.9

(51) Int. Cl. F16B 13/04

(52) U.S. Cl. 411/43

(57) ABSTRACT

The invention concerns a blind rivet (cup-, sleeve-shaped blind rivet) comprising a cap which is slipped over a blunt or pointed rivet shank, a method for producing a blind rivet comprising a cap, and a method for establishing a riveted joint by which a permanent connection between several workpieces is produced in one working step.

This application claims Paris Convention priority of DE 101 04 282.5 filed Jan. 30, 2001 and of DE 101 25 209.9 filed May 18, 2001 the complete disclosure of which are hereby incorporated by reference.

### BACKGROUND OF THE INVENTION

The invention concerns a blind rivet, a method for producing a blind rivet comprising a cap, and a method for establishing a riveted joint with that blind rivet.

A blind rivet (sleeve-shaped, cup-shaped blind rivet) is used for producing a permanent connection between or among workpieces, wherein only one side of the workpieces must be accessible for setting the rivet. A hole must usually be drilled before inserting the blind rivet. This requires an additional working step as well as a considerable amount of time.

To save time, a sleeve blind rivet (G 93 02 633) is provided with a tip which permits, by means of a device, penetration of the workpieces and anchoring of the blind rivet in one working step. Disadvantageously, only relatively thin-walled and soft plate materials can be penetrated. One reason therefor is the production method of the blind rivet, wherein the tip of the blind rivet is usually produced by massive forming (pressing). This method does not produce sharp, rather rounded tip edges which merely punch but do not cut through the workpieces. In addition, the material used cannot withstand the impact forces of the blind rivet setting device which are required for penetrating harder and/or thicker materials.

### SUMMARY OF THE INVENTION

In contrast thereto, the inventive blind rivet advantageously provides for a cap, slipped over the rivet sleeve of the blind rivet (cup-shaped, sleeve-shaped blind rivet) to e.g. subsequently vary the material properties or to compensate for previously drilled, excessively large holes. The inner diameter of the cap shaft which is slipped over the end of the rivet shank facing away from the rivet head or the mandrel end of the blind rivet facing the rivet shank thereby coincides with the outer diameter of the blind rivet.

In accordance with an advantageous embodiment of the invention, the cap shaft of the cup-shaped or sleeve-shaped cap is formed as tip and/or with sharp edges. In this manner, the workpieces can be penetrated in one working step with the blind rivet (cup, sleeve blind rivet) subsequently being anchored. Either blunt or pointed blind rivets can also be used in this connection. Sharp edges facilitate penetration of the workpieces and also permit penetration of harder and thicker materials.

In accordance with a further advantageous embodiment of the invention, the edges of the tip are sharpened or ground.

In accordance with a further advantageous embodiment of the invention, the tip is cut to sharpen the edges.

In accordance with a further advantageous embodiment of the invention, the tip has been cut to form sharp edges and is subsequently sharpened or ground.

In accordance with another advantageous embodiment of the invention, the cap consists of metal (special steel, aluminum, copper or the like) which meets special material requirements (e.g. hardness, corrosion resistance, conductivity) which the joint between the materials to be processed must fulfill.

In accordance with a further advantageous embodiment of the invention, the cap consists of a plastic material (polypropylene or the like) which satisfies special material requirements (e.g. insulation) which the joint between the materials to be processed must fulfill.

In accordance with a further advantageous embodiment of the invention, the cap consists of rubber or the like to satisfy the special material requirements (e.g. insulation, sealing, vibration absorption) which the joint between the materials to be processed must fulfill.

In accordance with a further advantageous embodiment of the invention, the cap comprises a cap rim to support the processed blind rivet on the workpiece.

In accordance with a further advantageous embodiment of the invention, the cap rim of the cap has an undercut on the side facing the workpiece which improves the support on the workpiece.

In accordance with a further advantageous embodiment of the invention, the cap rim of the cap comprises a sealing element on the side facing the workpiece which renders the connection between the workpieces provided by the blind rivet, liquid and gas-tight.

In accordance with a further advantageous embodiment of the invention, the tip subtends an angle of between 10° and 70° .

In accordance with a further advantageous embodiment of the invention, the tip has a multiangular (dagger-shaped, triangular, polygonal or the like) cross-section. The cutting edges therefore terminate at the outer end of the cap at one or more points.

In accordance with a further advantageous embodiment of the invention, the cap is connected to the blind rivet (pressed, clamped, glued or the like). This connection is provided mechanically or manually.

In the inventive method for producing a blind rivet, the blind rivet is provided with a cap and/or the rivet mandrel, the cup-shaped rivet shank or the cap are sharpened after or during the conventional working steps of mechanical production (e.g. cutting to length, compression, assembly of the individual parts).

In accordance with the present embodiment of the invention, the sharpening is carried out by pressing, cutting, sharpening or by a combination of cutting and sharpening.

In accordance with an advantageous embodiment of the inventive method, the cap is disposed and/or the cap is mounted onto the sleeve or cup blind rivet either manually or mechanically.

In the inventive method for establishing a riveted joint, in particular by means of a suitable device (shooting apparatus, blind rivet setting device), the tip of the blind rivet is formed by the pointed cap.

In accordance with such an embodiment of the inventive method, the workpiece is penetrated by cutting to facilitate penetration of the workpieces.

Further advantages and advantageous embodiments of the invention can be extracted from the following description, the drawing and the claims.

Embodiments of the subject matter of the invention are described in more detail in the drawing and below:

### BRIEF DESCRIPTION OF THE DRAWING

FIG. 1 shows a sectional view of a cup blind rivet with slipped over sleeve-shaped cap including cap rim;

FIG. 2 shows a sectional view of a sleeve blind rivet with slipped over sleeve-shaped cap including cap rim;

FIG. 3 shows a sectional view of a cup blind rivet with slipped over cup-shaped cap including cap rim;

FIG. 4 shows a sectional view of a sleeve blind rivet with slipped over cup-shaped cap including cap rim;

FIG. 5 shows a sectional view of a cup blind rivet with slipped over cup-shaped and sharpened cap including cap rim;

FIG. 6 shows a sectional view of a sleeve blind rivet with slipped over cup-shaped and sharpened cap including cap rim;

FIG. 7 shows a sectional view of a cup blind rivet with slipped over cu p-shaped and sharpened cap including cap rim and sealing element;

FIG. 8 shows a sectional view of a sleeve blind rivet with slipped over cup-shaped and sharpened cap including cap rim and sealing element;

FIG. 9 shows a sectional view of a cup blind rivet with slipped over cup-shaped and sharpened cap without cap rim; and

FIG. 10 shows a sectional view of a sleeve blind rivet with slipped over cup-shaped and sharpened cap without cap rim.

### DESCRIPTION OF THE PREFERRED EMBODIMENT

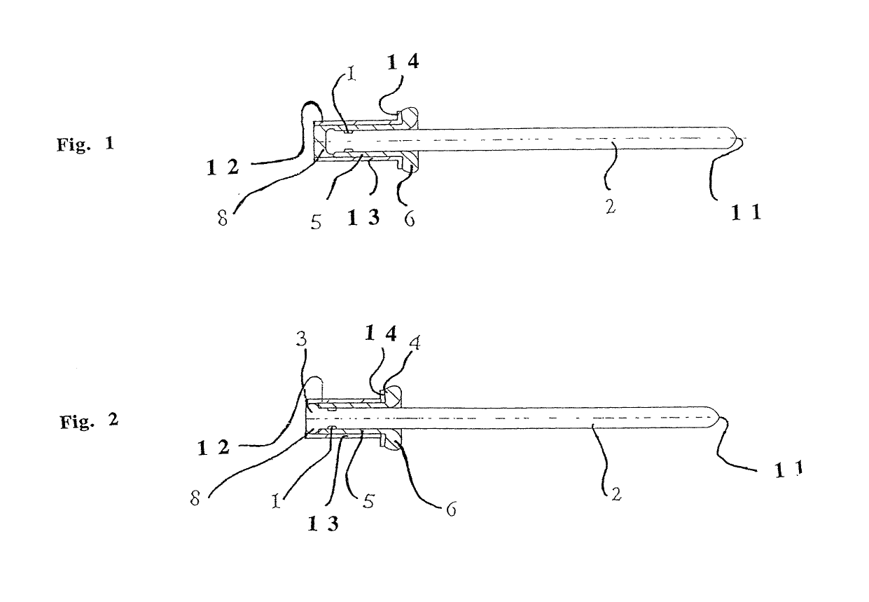

The blind rivet shown in FIG. 1 is a cup blind rivet and consists essentially of a rivet mandrel 2 comprising a mandrel end 11 and a rivet shank 5. The rivet shank 5 is subdivided into a rivet head 6 and a closing head 8. After pre-drilling of the workpieces, the rivet shank 5 of the blind rivet is inserted into the prepared hole. Subsequent pulling of the rivet mandrel 2 deforms the rivet shank 5 and the rivet head 8 thereby connecting the workpieces. This deformation is caused by a rod head 3 of a cup blind rivet which is drawn in the direction of the rivet head 6 for anchoring the cup blind rivet. The connection is provided on the one side of the workpieces to be connected by the deformation of the rivet shank 5 and the closing head 8 and on the other side of the workpieces by the rivet head 6 whose edge has a rivet head rim 4. After establishing the connection, the breaking point 1 permits separation of the rivet mandrel 2. FIG. 1 shows a sleeve-shaped cap 12 slipped over the rivet shank 5 which is provided with a cap rim 14 which can be undercut for improved support of the processed blind rivet on the workpiece. The shape of the cap shaft 13 is thereby optimally adjusted to the blind rivet. The use of a sleeve-shaped cap 12 may be required e.g. if the prepared hole is too large or when the connection of the workpieces to be processed must meet special material requirements which the blind rivet cannot otherwise fulfill.

The blind rivet shown in FIG. 2 is a sleeve blind rivet and consists essentially of a rivet mandrel 2 and a rivet sleeve. In this case as well, a sleeve-shaped cap 12 having a cap rim 14 is slipped over the rivet.

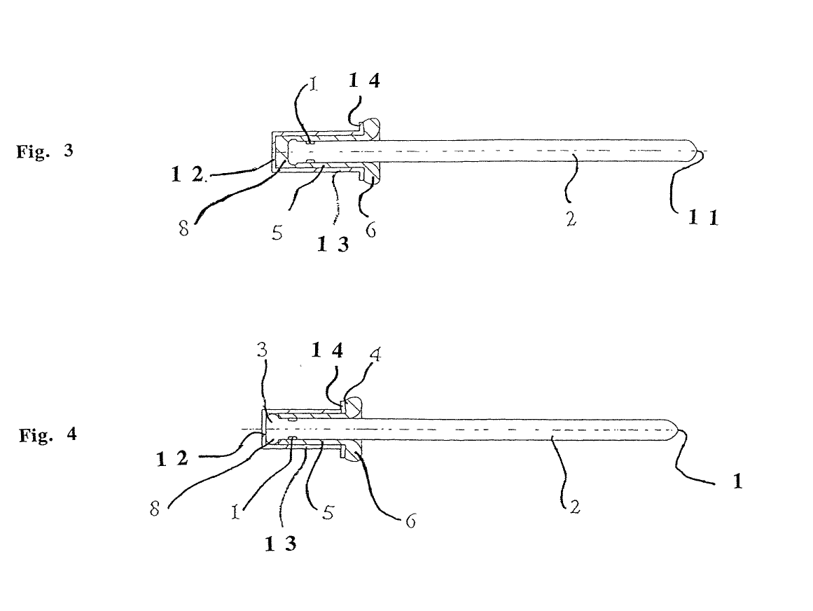

FIG. 3 shows a cup blind rivet which is provided with a cup-shaped cap 12 having a cap rim 14. The use of a cup-shaped cap 12 may be required e.g. if the prepared hole is too large or if the connection of the materials to be processed must meet special material requirements which the blind rivet cannot otherwise satisfy.

FIG. 4 shows a sleeve blind rivet which is provided with a cup-shaped cap 12 having a cap rim 14.

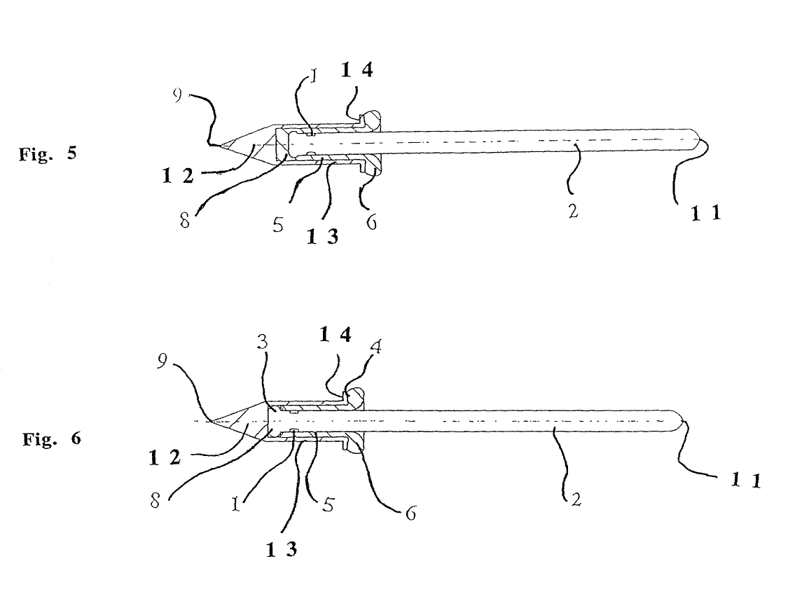

FIG. 5 shows a cup blind rivet which is provided with a cup-shaped sharpened cap 12 having a cap rim 14. The sleeve-shaped cap 12 can also have a tip 9. This tip permits penetration of the blind rivet through the workpieces without previous drilling. The use of a sharp cap 12 (sleeve or cupshaped) in connection with a pointed blind rivet (cup, sleeve blind rivet) is advantageous due to possible variation of the material properties (e.g. hardness, corrosion resistance, conductivity).

FIG. 6 shows a sleeve blind rivet which is provided with a cup-shaped sharpened cap 12 having a cap rim 14. In this case as well, a sleeve-shaped cap 12 having a tip 9 can also be used.

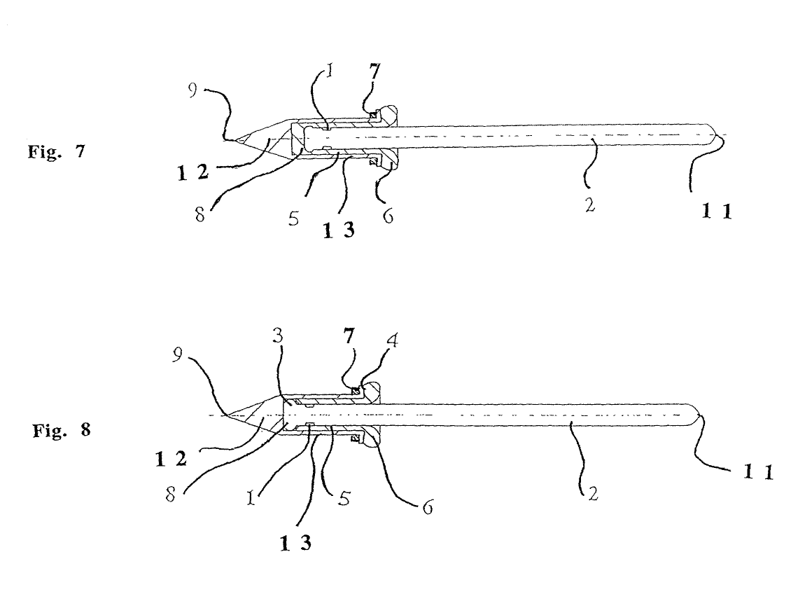

The blind rivet shown in FIGS. 7 and 8 (cup, sleeve blind rivet) is provided with a cap 12 having a sealing element 7 which seats between the workpiece and the rivet head 6 after connection to provide a liquid- and gas-tight sealing. The sealing element 7 can also be provided in all other embodiments of the cap.

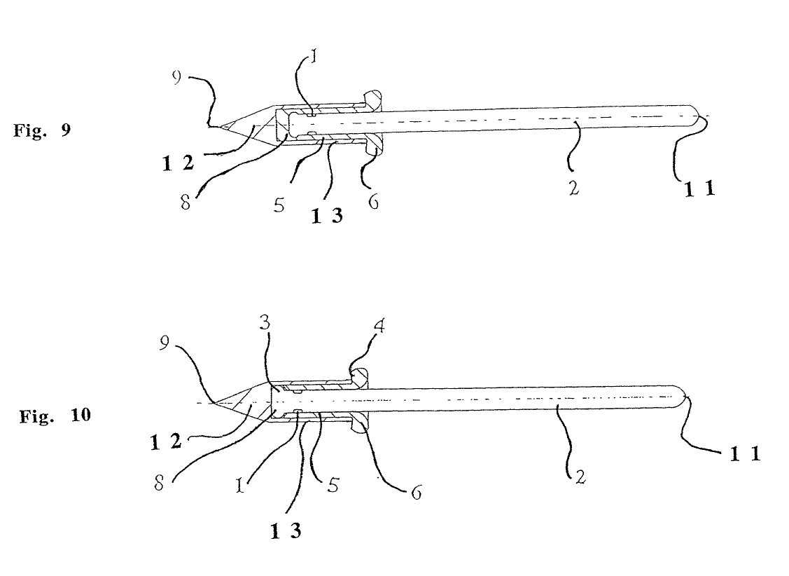

The blind rivet (cup, sleeve blind rivet) shown in FIGS. 9 and 10 has a cap 12 without a cap rim 14. The cap rim 14 can also be omitted in all other embodiments of the cap. This variant can be advantageously used in connection with a blind rivet comprising a sealing element.

All the features shown in the description, the following claims and in the drawings may be essential to the invention either individually or collectively in any arbitrary combination.

List of Reference Numerals

1Breaking point

2rivet mandrel

3rod head

4rivet head rim

5rivet shank

6rivet head

7sealing element

8closing head

9tip

11mandrel end

12cap

13cap shaft

14cap rim

We claim:

1. A blind rivet for connecting adjacent workpieces, the blind rivet comprising:
a bushing, said bushing being one of cup-shaped and sleeve-shaped, said bushing having a bushing shank and a bushing head integral with and disposed at one end of said bushing shank;
a mandrel, said mandrel passing through said bushing head to project into said bushing shark, said mandrel having a mandrel head disposed at a first end region within said bushing shark opposite said bushing head, said mandrel having a breaking location disposed between said mandrel head and said bushing head, said mandrel having a mandrel end region extending past said bushing head outside said bushing; and
a cap surrounding said bushing shank, said cap having a cap shaft which is one of cup-shaped and sleeve-shaped, wherein said cap is slipped over a front end of said bushing shank.

2. The blind rivet of claim 1, wherein an inner diameter of said cap shaft coincides with an outer diameter of said bushing shank of the blind rivet.

3. The blind of claim 1, wherein said cap shaft has at least one of sharp edges on an end thereof facing away from said mandrel end.

4. The blind rivet of claim 3, wherein said cap has a tip processed to have sharp edges.

5. The blind rivet of claim 3, wherein said cap has a tip cut to have sharp edges.

6. The blind rivet of claim 3, wherein said cap has a tip initially cut to have sharp edges and then subsequently sharpened.

7. The blind rivet of claim 1, wherein said cap consists essentially of one of metal, special steel, aluminum, and copper.

8. The blind rivet of claim 1, wherein said cap consists essentially of one of a plastic material and polypropylene.

9. The blind rivet of claim 1, wherein said cap consists essentially of rubber.

10. The blind rivet of claim 1, wherein a rear end of said cap has a cap rim.

11. The blind rivet of claim 10, wherein said cap rim has an undercut on a side thereof facing said cap shaft.

12. The blind rivet of claim 10, wherein said cap rim is provided with a sealing element on a side thereof facing said cap shaft.

13. The blind rivet of claim 1, wherein said cap has a tip, said tip having edges subtending an angle of between 10° and 70°.

14. The blind rivet of claim 1, wherein said cap has a tip, said tip having polygonal cross-section.

15. The blind rivet of claim 1, wherein the blind rivet is structured to form one of a compression joint, an adhesive connection, and a screw joint.

16. A method for producing the blind rivet of claim 1, the method comprising the steps of:
a) cutting said mandrel to lengths;
b) precompressing and shaping said mandrel head;
c) precompressing and shaping of said a bushing shank;
d) assembling said mandrel, said bushing and said cap;
and
e) sharpening at least one of said mandrel, said bushing, and said cap.

17. The method of claim 16, wherein step e) comprises at least one of pressing, cutting, sharpening, and grinding.

18. The method of claim 16, wherein said cap is one of disposed on the blind rivet, fixed manually on the blind rivet and fixed mechanically on the blind rivet.

19. A method for using the blind rivet of claim 1 to establish a riveted joint, wherein the blind rivet is applied within one of a shooting apparatus and a blind rivet setting device, the blind rivet having said rivet mandrel with said breaking point, said bushing head and said cup- or sleeve-shaped bushing shank, wherein said rod head located proximate said breaking point of said mandrel, penetrates in front of said bushing shank through one or more workpieces to be connected and up to an abutment, wherein, while simultaneously supporting said bushing head, said mandrel is drawn opposite to a drilling direction to form a closing head extension on a side of the bushing shank opposite said bushing head for producing the connection, wherein said mandrel is separated by exceeding a predetermined force for said breaking point, wherein said cap defines a pointed tip of the blind rivet formed by disposing said cap with said pointed top, over said bushing shank of the blind rivet.

20. The method of claim 19, wherein at least one workpiece is penetrated by cutting.
